(19) United States
(12) Patent Application Publication
(10) Pub. No.: US 2002/0034220 A1
(43) Pub. Date: Mar. 21, 2002

(54) Apparatus and method for digital subscriber line signal communications

(76) Inventor: Tom Duxbury, Dunrobin (CA)

Correspondence Address: DOWELL & DOWELL PC, SUITE 309, 1215 JEFFERSON DAVIS HIGHWAY, ARLINGTON, VA, 22202

(21) Appl. No.: 09/956,855

(22) Filed: Sep. 21, 2001

Related U.S. Application Data
(60) Provisional application No. 60/234,237, filed on Sep. 21, 2000.

(51) Int. Cl. H04L 5/16; H04B 1/38

(52) U.S. Cl. 375/222

(57) ABSTRACT

A communication system is provided for Digital Subscriber Line (DSL) communications comprising a radio transmitter for receiving a DSL signal and having a converter for converting the DSL signal into an RF signal for wireless transmission. A radio receiver is arranged to receive the RF signal containing the DSL signal and convert the RF signal into the original DSL signal for continued transmission.

### FIELD OF THE INVENTION

The present invention relates to digital subscriber line signal communications and, in particular to a system and method for implementing digital subscriber line communications.

### BACKGROUND OF THE INVENTION

Broadband data network services are commonly being deployed with Digital Subscriber Line (DSL) access methods, such as Asymmetrical Digital Subscriber Line (ADSL) or Very high speed DSL (VSDL). These are well known access methods which modulate a bi-directional data path on the same pair of wires as the existing Plain Old Telephone Service (POTS) and are normally implemented in frequency bands above the normal audible range or the voice band used for POTS, by adopting transmission schemes which use frequencies up to those which are transmittable over twisted copper pairs. ADSL and VDSL allow data to be transmitted at much higher rates than existing analog modems and Integrated Services Digital Network (ISDN). Thus, ADSL and VDSL enable an existing telephone wire connection between a central office and a subscriber's residence to be extended in function to carry data services such as internet traffic. ADSL, which may implemented as the ANSI standard T1.413, is designed to operate only on copper loops, and requires termination equipment at the subscriber and central office ends of the links Unlike analog in band modems, such as ANSI V.34, the data is carried outside of the voice band and therefore allows the transmission of data and POTS to be implemented simultaneously on the same line, As ADSL is above the voice band, it cannot be switched by the Public Switched Telephone Network (PSTN) but rather passes through a separate interface and so avoids and does not contribute to congestion at the central office switch. A typical implementation of ADSL is shown in FIG. 1.

Referring to FIG. 1, a POTS telephone subscriber line 1 is provided to a private residence 3 which is equipped with one or more telephone sets 5 and one more computer terminals 7. A POTS splitter 9 is connected between the subscriber's equipment and the telephone socket to separate the voice and ADSL frequency bands of incoming signals and direct voice band signals to the telephone set and ADSL signals to an ADSL modern 11. The modem 11 converts the ADSL signal into a bit stream which is passed to the computer 7. The ADSL modem also converts signals output from the computer into an ADSL signal for transmission over the telephone subscriber line. The other end of the telephone subscriber line is connected to a Central Office (CO) 13 where a second POTS splitter 15 separates the voice band frequency signals from the incoming combined POTS voice and ADSL signals and passes the POTS signal to a telephone switch 17, in the usual way. The POTS splitter 15 directs the ADSL data signal to an ADSL Multiplexer, e.g. a Digital Subscriber Line Access Multiplexer (DSLAM) 19 which typically concentrates the number of ADSL subscriber lines into a single Asynchronous Transfer Mode (ATM) line.

ADSL is commonly implemented with a modulation scheme known as discrete multi-tone modulation, versions of which are described for example in U.S. Pat. No. 6,072,779 to Tzannes, et al., issued on Jun. 6, 2000, U.S. Pat. No. 5,598,435 to Williams, issued on Jan. 28, 1997 and U.S. Pat. No. 5,479,447 to Chow, et al., issued on Dec. 26, 1995, the disclosures of which are incorporated herein by reference. In this method, the telephone wire baseband spectrum is divided into 256 frequency bins each having center frequencies separated by about 4 kHz and each having a width of about 4 kHz. Each 4 kHz bin is treated as an individual data channel of varying capacity, as is the ANSI standard V.34. The first eight frequency bins are normally reserved for carrying POTS voice. Referring to FIG. 2, the data traffic from the subscriber to the Central Office (referred to as the upstream direction) is carried in a number of successive frequency bins above those reserved for the voice channel 21 and data traffic from the Central Office to the subscriber (referred to as the downstream direction) is carried in a number of successive bins within a frequency band 25 above the upstream frequency band 23.

One limitation of DSL technology is the traffic carrying capacity of a telephone loop, which falls off dramatically with distance. Causes for this are attributable to a number of factors including: high frequency roll-off due to wire capacitance, degradation in signal quality due to in band interference (e.g. AM radio) and other impulse noise sources, poor and frequent cable splices, poor insulation, cable impedance changes, unterminated cable stubs (producing signal reflections) as result of bridge tapped installations, the presence of high frequency loading coils, and the coexistence of other DSL services (such as T1) within the cable bundle.

The result of such interference on the installed base of telephony wires is that implementations of DSL are limited in wire length. For example, ADSL has a practical deployment limitation of about 12,000 feet of cable distance. Although acceptable service has been achieved in some instances up to 18,000 feet, there remain a significant number of potential subscribers who cannot access ADSL services due to problems with their telephone loop, of which distance is the prime inhibitor. Conversely, there are significant numbers of subscribers with shorter length loops who cannot achieve acceptable levels of data carrying service due to other causes, such as cross-talk and RF interference. In many cases, it is simply not economically feasible for a data service provider to correct such difficult problems, and the subscriber is disqualified as a customer.

One known solution to the problem of distance limitation is to power boost the transmit levels of the attachment equipment. However, this solution has proved to be unworkable as the resulting near-end cross-talk (NEXT) levels become too high so that transmitted data couples into the near end receiver. In addressing the problem of bridged taps and loading coils, the only solution proposed is to re-engineer the cable plant which is a prohibitively expensive proposition.

A second practical problem with DSL deployment, aside from poor loop quality, is the existence of a Digital Loop Carrier (DLC) between the residence and the Central Office. A digital loop carrier is an alternative form of telephony attachment which results in a non-continuous copper path between a subscriber's telephone and the central office. However, ADSL is designed to operate only on copper loops and requires termination equipment at the subscriber and CO ends of the link. To implement ADSL in such cases, the central office side terminating equipment must reside in the DLC cabinet rather than the central office itself which further complicates and delays service availability. In many cases, there is simply no room in the cabinet for DSL termination equipment, and again, service may be denied to a potential subscriber A typical example of a DLC deployment scheme is shown in FIG. 3.

Referring to FIG. 3, a digital loop carrier 27 terminates telephone subscriber lines 29, 31 serving respective subscriber's premises 33, 35 and converts the POTS signal for digital transmission to the central office 13, for example over a fibre optic cable 37. Thus, the DLC interrupts the continuous copper path between the subscriber and Central office, preventing the transmission of DSL signals.

### SUMMARY OF THE INVENTION

According to one aspect of the present invention there is provided a radio transmitter having a signal input adapted to receive a digital subscriber line signal, a signal converter for converting the digital subscriber line signal into a radio signal for wireless transmission and an antenna for transmitting the radio signal.

According to another aspect of the present invention, there is provided a radio receiver comprising an antenna for receiving a wireless RF signal containing data for transmission on a digital subscriber line signal, a converter for converting the received RF signal into a digital subscriber line signal and an output for outputting the digital subscriber line signal.

The radio transmitter and receiver allow DSL signals to be transmitted over the air, thereby allowing problems associated with long lengths and the quality of telephone wire lines and potential barriers to DSL signals between a subscriber's residence and the central office to be bypassed. Thus, the invention can increase the transmission capacity of a telephone wire line network between a subscriber and the central office and make DSL communications accessible to subscribers who would otherwise be denied access due to the distance between a residence and the central office, the presence of DSL signal barriers or poor quality telephone subscriber lines.

### BRIEF DESCRIPTION OF THE DRAWINGS

Examples of embodiments of the present invention will now be described with reference to the drawings, in which:

FIG. 1 shows a schematic diagram of an implementation of ADSL communication between a residence and a Central Office according to the prior art;

FIG. 2 shows a diagram of the frequency bands typically used in implementing ADSL;

FIG. 3 shows a schematic diagram of an implementation of digital loop carrier deployment according to the prior art;

FIG. 4 shows a schematic diagram of one example of an application of an embodiment of the present invention;

FIG. 5 shows a block diagram of a radio transceiver according an embodiment of the present invention;

FIG. 6 shows a diagram of an example of the frequency bands used in the implementation of the embodiment of FIG. 5;

FIG. 7 shows a block diagram of the components of the embodiment of FIG. 5 in more detail and,

FIG. 8 shows a schematic diagram of another implementation of an embodiment of the present invention.

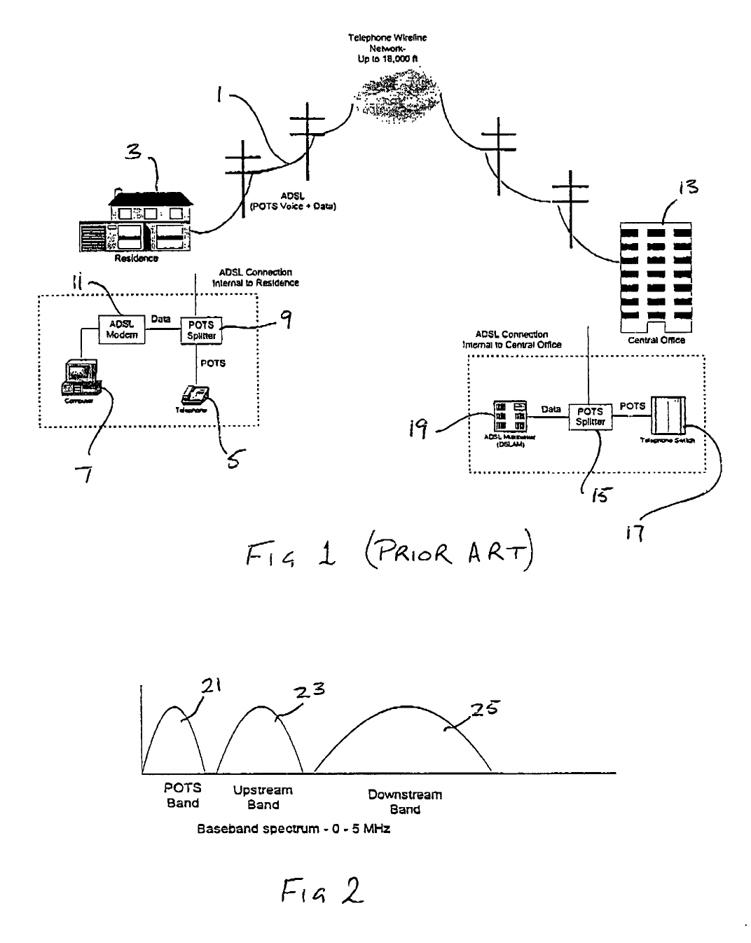

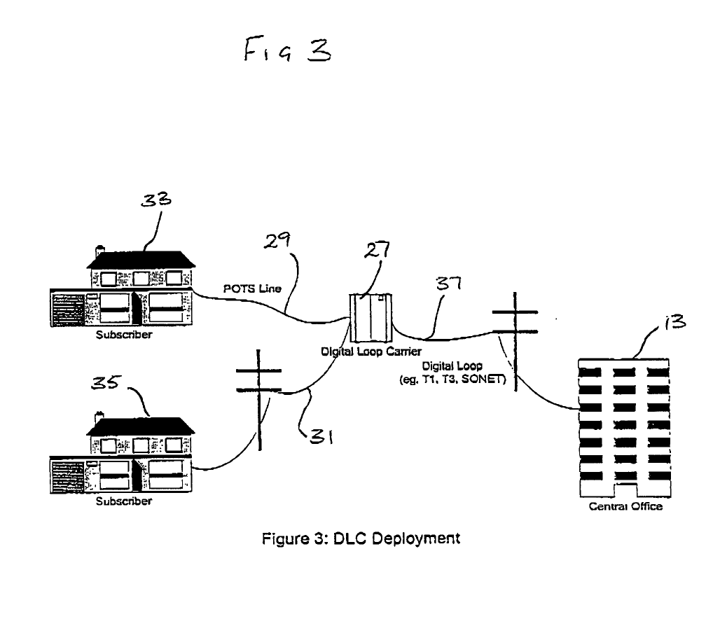

### DESCRIPTION OF PREFERRED EMBODIMENTS

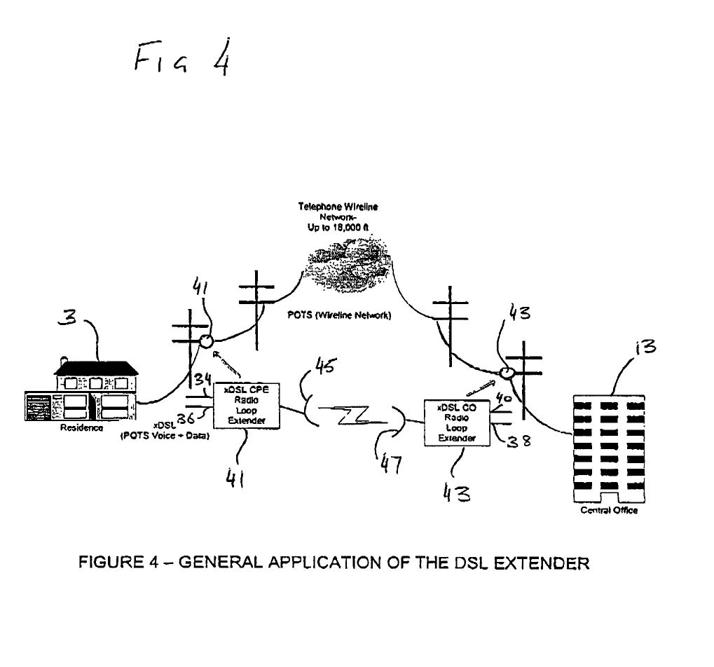

Referring to FIG. 4, a communication system according to an embodiment of the present invention is shown between a subscriber's residence 3 and a central office (CO) 13. The communication system includes a first DSL radio transceiver 41 having a DSL signal input 34 and a DSL signal output 36 connected to the subscriber's telephone wire line at the customer premises end (CPE), for example a short distance from the subscriber's residence 3. A second DSL transceiver 43 has a DSL signal input 38 and a DSL signal output 40 which are also connected to the subscriber's telephone wire line, but at a position upstream of the first transceiver, for example near or at the central office end of the subscriber line. Each radio transceiver 41, 43 has a transmitting portion which converts the DSL signal carried on the telephone subscriber line into an RF signal for wireless transmission and a receiver portion which receives an RF signal containing DSL data and converts the RF signal into a DSL signal for continued transmission over the telephone subscriber line. Each radio transceiver includes a radio antenna 45, 47, for transmitting and receiving radio waves between the two radio transceivers. The radio antennas 45, 47 may comprise either separate receive and transmit antennas or single antennas which both receive and transmit RF signals. Thus, the pair of DSL radio transceivers 41, 43 establishes a bi-directional communication link for the transmission of DSL signals which bypasses the desired segment of the telephone subscriber line between the subscriber's residence and the Central Office.

In one embodiment of the invention, a frequency separator separates the high frequency DSL traffic, which is normally above 16 kHz, from the signal carried on the telephone wire line, for radio transmission, while the low frequency voice channel signal which is not subjected to the same transmission problems as the DSL signal is allowed to continue to propagate down the existing wire line path. In another embodiment of the invention, the frequency separator may be dispensed with and the transceiver used to receive and transmit both voice and DSL signals.

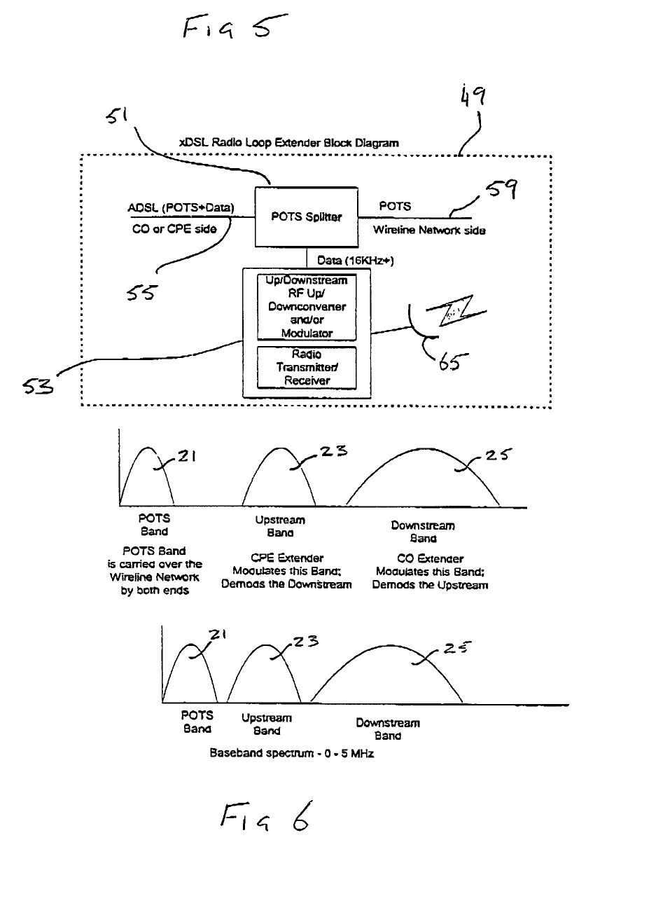

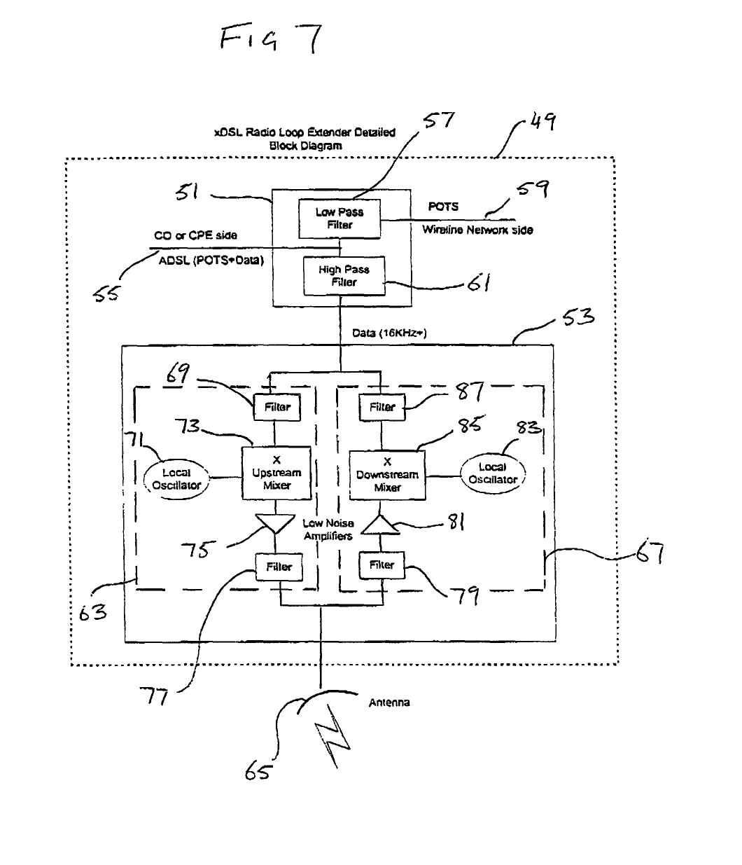

FIGS. 5 and 7 show block diagrams of an embodiment of a DSL radio transceiver in more detail. Similar transceiver units may be used at each end of the RF communication link (e.g. at the subscriber and central office ends) and an embodiment of the radio transceiver will firstly be described for use at the subscriber side, in which RF downstream traffic is received and RF upstream traffic is transmitted.

Referring to FIGS. 5 and 7, the radio transceiver 49 includes a frequency separator 51, which may be a conventional POTS splitter and a radio transceiver section 53. Both the frequency separator and transceiver section may be housed within the same unit or different units. As shown in FIG. 7, the frequency separator 51 receives and transmits on the telephone subscriber line 55 combined DSL and POTS signals. The frequency separator comprises a low pass filter 57 which passes only POTS voice band signals onto the network side of the telephone subscriber line 59, so that these signals continue to propagate over the wire line network to the central office. The frequency separator 51 further comprises a high pass filter 61 for passing only DSL band signals, i.e. upstream DSL signals received from the customer premises end of the telephone subscriber line and downstream DSL signals from the DSL radio transceiver section 53. For example, the high pass filter may be arranged to pass signals having frequencies above 16 kHz or any other suitable frequency above or below this value.

The radio transceiver section 53 comprises a transmitter section 63 for converting upstream DSL signals into RF signals for wireless transmission by the antenna 65, and a receiver section 67 for receiving wireless, downstream DSL signals from the antenna 65 and converting the RF signals into base band DSL signals for transmission over the telephone subscriber line between the DSL radio transceiver and the customer premises.

The transmitter section 63 of the radio transceiver section 53 includes a first filter 69 for receiving upstream DSL data from the frequency separator 51, a local oscillator 71 and a mixer 73 for modulating the DSL signal onto a carrier signal, an amplifier 75, which is preferably a low noise amplifier, for amplifying the RF signal output from the mixer 73 and a second filter 77 for removing sideband RF signals generated by signal modulation.

The receiver section 67 of the radio transceiver section 53 includes a first filter 79 for passing RF signals within the downstream RF frequency band from the antenna 65 and blocking upstream RF signals generated by the transmitter section 63, an amplifier 81, which is preferably a low noise amplifier, for amplifying the RF signal passed by the first filter 79 of the receiver section, a local oscillator 83 and a mixer 85 for demodulating the RF signal into a baseband downstream DSL signal and a second filter 87 for filtering noise and signals resulting from the demodulation process from the resulting DSL base band signal. The downstream DSL signal is fed to the frequency separator 51 and combined with any POTS voice channel signal for transmission over the telephone subscriber line 55 to the customer premises.

As mentioned above, the embodiment of the DSL radio transceiver shown in FIGS. 5 and 7 may also be implemented at the Central Office or other service provider side of the wire line network. In this case, wire line 55 carries DSL and POTS signals from the Central Office (or another service provider or a combination of both) and the frequency separator 51 separates the POTS voice band signals from the DSL band signals and passes the POTS signal onto the network side of the telephone subscriber line for wire transmission to the subscriber premises. On the other hand, the DSL band signals are passed via the high pass filter 61 to the transmit section 63 of the radio transceiver section 53. The filter 69 passes the down stream DSL signal to the mixer 73 for modulation with an RF carrier frequency, the resulting RP signal is amplified by the amplifier 75, the amplified signal is then filtered, for example to remove side bands resulting from signal modulation, by the filter 77 and passes to the antenna 65 for downstream wireless transmission to an RF receiver at the subscriber side of the RF link. The receiver section 67 of the DSL radio transceiver 53 receives, via the antenna 65, upstream wireless RF DSL signals from a transmitter at the subscriber side of the radio link. The RF signal is passed through the first filter 79 of the receiver section 67, amplified by the amplifier 81 and demodulated by the mixer 85 of the receiver section 67 into a base band upstream DSL signal. The upstream DSL signal is then passed through the second filter 87 of the receiver section to the frequency separator 51 and output on to the wire line 55 for transmission to the Central Office or other service provider.

Although the frequency separator 51 and the transceiver section 53 may be housed within the same enclosure, in other embodiments, the frequency separator 51 and transceiver section 53 may be housed in different enclosures. The receiver and transmitter and section 63, 67 may be housed within the same enclosure or each in a separate enclosure which are located adjacent one another or in separate, spaced apart locations.

In other embodiments, for example where signals from the DSL radio receiver are passed to the Central Office or service provider over a communication link other than a twisted pair, for example an optical fibre, a coaxial cable or another radio link, a signal converter may be provided to convert the DSL signal output from the radio receiver into a signal suitable for transmission over that alternative communication link. Similarly, where signals received for RF transmission by the DSL radio transceiver are received from a source, e.g. a Central Office or another service provider over a communication link which carries signals different to DSL signals, a signal converter can be provided to convert the non-DSL signals to DSL signals before conversion to RF radio signals for wireless transmission by the transmitter.

The DSL signal may be generated by any suitable means and may have any DSL format. For example, the DSL signal may comprise a single encoded carrier frequency or channel, or a plurality of carriers or channels each having a different frequency, and which may also be encoded. Separate channels may be generated using frequency division multiplexing or discrete multitone modulation techniques, and the or each carrier may be encoded using quadrature phase amplitude modulation or by any other suitable technique. The DSL signal may contain any number of channels for downstream and upstream communications, for example 256 channels may be used for downstream communications and 32 channels may be used for upstream communications.

The transmitter may include any suitable means for converting or increasing the frequency of the or each DSL carrier frequency to the desired frequency for RF transmission, including means, for example a modulator or frequency converter for increasing one or more frequencies by an incremental frequency (e.g. by frequency addition), a frequency multiplier for increasing the frequency of one or more carriers by a predetermined factor, or a combination of any one or more frequency modulators, converters, or multipliers. Similarly, the receiver may comprise any suitable means for recovering the DSL signal from the RP signal, including any suitable means for removing the RF carrier frequencies and detecting the DSL signal, which may include one or more down converters for converting the RF signal into an intermediate frequency signal and/or one or more frequency demodulators and/or one or more frequency dividers. The same frequency reduction techniques can be applied to recover each channel or different frequency reduction techniques may be applied to recover different channels or carriers of the original or baseband DSL signal.

An example of the frequency spectrum of the POTS band, the upstream DSL band and the downstream DSL band are shown in FIG. 6. In one embodiment, the base band spectrum typically ranges from 0 to 5 MHz with the DSL upstream frequency band 23 being below the DSL downstream frequency band 25, although in other embodiments, the DSL upstream frequency band could be above the DSL downstream frequency band, and/or the up and down stream bands could overlap.

Advantageously, the power to drive the DSL radio transceiver can be derived from the DC voltage on the telephone wire line, supplied by the central office, to which the transceiver has direct access, thereby removing the need for a separate power supply. In other embodiments, for example where more power is required, a separate power supply could be used.

The DSL transceiver unit could be positioned at an end point of the telephone subscriber line for example at the customer premises end or the central office end or at a position or positions between the customer premises and the central office, for example to avoid and bypass selectively particular portions of the wire line network. The transceiver units are preferably mounted at elevated positions, for example on roof tops, the sides of buildings or existing communication structures, such as a telephone poles.

The wireless DSL signal may be transmitted over any suitable frequency or frequency band, for example an unlicensed frequency band, such as the Instrumentation, Scientific and Medical (ISM) Band at 2.5 GHz. In one embodiment, the upstream DSL signals could be up converted from approximately 25 kHz to 125 kHz to the RF band between 2.40 and 2.405 GHz. The downstream DSL signal could be up-converted from the 125 kHz to 1.1 MHz range to occupy the RF band between 2.45 to 2.455 GHz. A frequency division multiplexing FDM scheme which is used to transmit information on different frequencies over the same medium, could be used to implement embodiments of the invention.

Alternatively echo cancellation techniques could be used in which up and downstream dates are carried on overlapping frequency bands.

In further embodiments of the invention, a single transceiver unit may be arranged to receive and/or transmit DSL signals received from or to be directed to the same and/or different telephone subscriber lines. For example, a single transceiver unit may serve multiple telephone subscriber lines from a number of different customers or customer premises or be positioned at the central office side of the telephone wire line network or at another service provider and transmit to and receive from a plurality of DSL transceiver units, for example positioned at the customer premises side of the telephone wire line network. The DSL radio transmitter may transmit RF DSL signals to a plurality of DSL radio receivers over different frequency channels, each allocated to a different receiver or on the same channel frequency using time division multiplexing and/or encoding/decoding techniques. Similarly, a single DSL radio receiver may receive wireless DSL signals from a plurality of DSL radio transmitters, each transmitting on different frequency channels or on the same channel and using time division multiplexing or encoding/decoding techniques.

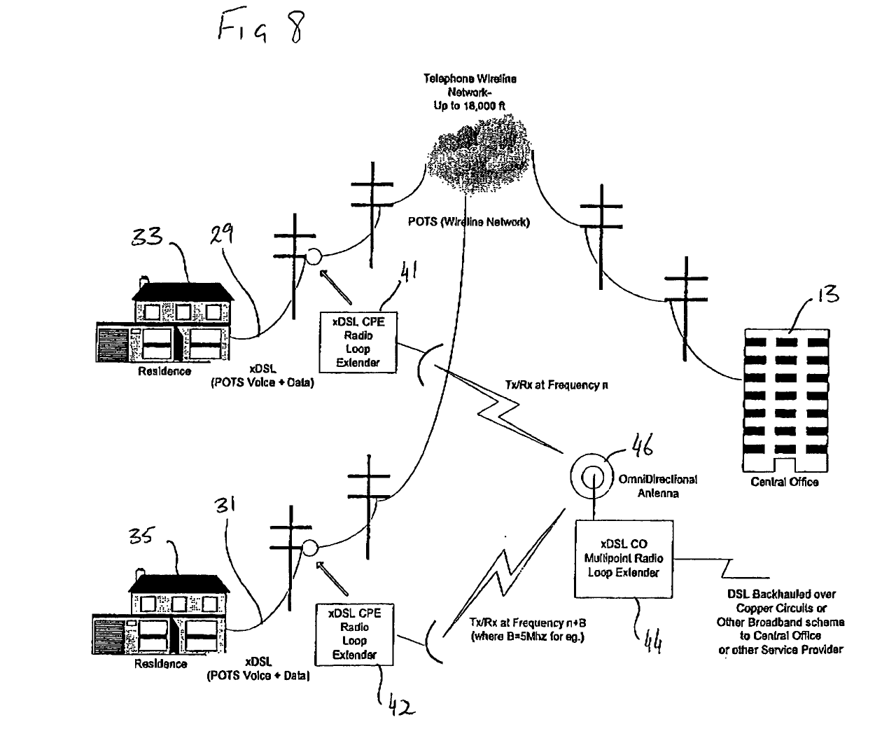

An example of an implementation of a transceiver unit which communicates with a plurality of other transceiver units is shown in FIG. 8. Referring to FIG. 8, a plurality of subscribers' premises 33, 35 are each connected to a central office by a telephone wire line 29, 31. A DSL radio transceiver 41, 42 is connected to the telephone subscriber line 29, 31 associated with a respective customer premises 33, 35 at the CPE side of the telephone wire line network. A third DSL radio transceiver unit 44 is located at a suitable location some distance away from the subscriber DSL radio transceivers 41, 42. The third radio transceiver unit 44 receives DSL signals intended either for the first or second subscriber premises 33, 35, for example from a central office or another service provider. The third transceiver 44 may include means for discriminating, for example, by virtue of data carried in the DSL signals, (e.g. the signal overhead or by some other means, e.g. time division multiplexing), the subscriber to which the DSL signal is intended to be transmitted. Once the recipient subscriber has been identified, the third transceiver unit may direct the wireless DSL signal to the associated subscriber transceiver unit 41, 42 by, for example, transmitting the wireless RF signal over a channel which is specifically dedicated to that subscriber radio transceiver, by transmitting the RF signal using a directional radio link, which may be implemented by using a highly directional antenna directed at the receiving antenna of the subscriber transceiver unit, or by using a combination of these techniques. In the directional link technique, RF DSL signals for different subscribers may be transmitted on the same channel and frequency, the RF DSL signals intended for different recipients being separated according to their direction. In the embodiment shown in FIG. 8, the third transceiver unit 44 includes an omni-directional antenna 46 which is capable of receiving simultaneously wireless RF signals from a plurality of subscriber DSL radio transceiving units and broadcasting simultaneously DSL RF signals on a plurality of RF channels, each assigned to a particular subscriber.

In another embodiment, the wireless DSL signal may be encoded with a subscriber identifier and a subscriber identity decoder may be provided at the subscriber end of the radio communication link, for example, in the subscriber DSL radio transceiver unit which passes only those DSL signal intended for a particular subscriber.

The third transceiver unit 44 may receive and/or backhaul DSL signals to the service provider or central office using any one or combination of suitable means, including radio link, fiber optics, copper path and, co-axial cables.

Embodiments of the invention may be implemented for use with any form of DSL for example, HDSL (High Data Rate DSL), RADSL (Rate Adaptive ADSL), ADSL (Asymmetric Digital Subscriber Line), SDSL (Symmetric Digital Subscriber Line), VDSL (Very High Data Rate DSL), and VADSL (very High Speed ADSL) as well as others.

DSL radio transmitter/receiver pairs according to embodiments of the present invention may be positioned to bypass any one or more of a digital loop carrier, one or more high frequency loading coils, long or short lengths of wire line, one or more wire line splices and joins and one or more discontinuity in a wire line and portions of the wire line which are subjected to interference, for example either electrical or mechanical or from other sources. More than one radio pair may be used to provide a radio link between a subscriber and the central office or other service provider, for example where the range of a radio link between a single DSL RF transmitter and receiver pair is insufficient to bypass the desired wire line segment between the subscriber and Central Office or other service providers.

The DSL radio transmitter and DSL radio receiver according to embodiments of the present invention, offer an effective solution to the problem of DSL transmission over telephone wire line networks for which DSL transmission schemes were intended. Embodiments of the invention also advantageously improve over existing solutions to DSL transmission problems in which, for example, DSL, such as Ti loop extension is performed using copper path regenerators.

Such wire-based regenerators suffer from drawbacks such as limited range, noise accumulation, excessive power consumption and failure to address fundamental network topology problems, such as DLC's, bridged taps and loading coils. Embodiments of the present invention overcome the problem presented by DLC's which is a particularly vexing problem for DSL deployment, by bypassing the DLC's by transmitting the DSL signal using wireless RF transmission.

In other embodiments of the present invention, the DSL radio transceivers may be implemented without the presence of an existing wire line network at one or both ends. This would allow subscribers in remote areas without access to an existing wire line network to access DSL transmission schemes without the need and expense of providing a wire connection to the telephone subscriber line network.

Advantageously, embodiments of the present invention offer a solution which can be implemented relatively simply over other potential solutions to the problem of DSL transmission. Advantageously, embodiments of the invention allow direct conversion of the wire line base band DSL signal into a wireless RF signal by for example, signal up/down conversion and/or modulation, thereby achieving significant cost and complexity savings over other potential approaches, for example, which involve the complete recovery and retransmission of the DSL signal. Such signal recovery would require the use of complex integrated circuits, microprocessors and/or state machines to properly terminate the link. In contrast, the RF conversion of the DSL signal according to embodiments of the present invention does not require the signal to be terminated but rather re-broadcast at the physical layer over an alternate medium and spectrum. A further benefit of direct conversion is that the RF portion of the link is “transparent” to the end point algorithms which adapt to the link's performance characteristics. Thus, in a discrete multi-tone modulation implementation of DSL, such as T1.413 ADSL or a DMT implementation of VDSL, the DMT algorithm would take into account any spectral characteristics introduced by the wireless transport mechanism, as well as the wire network for which it was designed.

Embodiments of the invention allow DSL to be deployed with a considerable reduction in complexity and power requirements as compared to other potential solutions. Furthermore, embodiments of the present invention allow existing DSL services to be improved, for example, improving transmission speed capability and/or capacity, effectively providing VDSL capability where only ADSL was previously an option and allow problematic infrastructure such as digital loop carriers, misconfigured telephone lines (e.g. bridged taps, loading coils), as well as noise and cross-talk prone sections of telephone lines to be by-passed.

Modifications and alternatives to the embodiments described above will be apparent to those skilled in the art.

1. A communication system comprising:
(a) a generator for generating a digital subscriber line (DSL) signal, and
(b) a radio transmitter arranged to receive the DSL signal and having a converter for converting the DSL signal into an RF signal for wireless transmission.

2. A communication system as claimed in claim 1, wherein the radio transmitter further comprises an antenna for radiating the RF signal.

3. A communication system as claimed in claim 1, wherein the DSL signal is contained in a frequency band above the audio frequency band allocated for voice channels on the telephone subscriber line.

4. A communication system as claimed in claim 3, wherein the generator is arranged to output the generated DSL signal onto a telephone subscriber line.

5. A communication system as claimed in claim 1 further including a frequency filter for removing voice band frequency signals from the signals passed from the generator to the radio transmitter.

6. A communication system as claimed in of claim 1, further including a frequency separator for separating DSL signals from voice band signals and arranged to pass the separated DSL signals to the radio transmitter.

7. A communication system as claimed in claim 6, wherein the frequency separator is arranged to pass voice band signals to one of a digital loop carrier (DLC) and a high frequency loading coil, and to pass the DSL signal to the radio transmitter.

8. A communication system as claimed in claim 1, wherein the generator generates the DSL signal by amplitude and/or phase modulating at least one carrier frequency.

9. A communication system as claimed in claim 8, wherein the generator generates the DSL signal by amplitude and/or phase modulating a plurality of carrier frequencies.

10. A communication system as claimed in claim 1, wherein the generator generates the DSL signal by performing discrete multi-tone modulation (DMT) and/or quadrature phase amplitude modulation (QAM).

11. A communication system as claimed in claim 1, wherein the generator is arranged to generate a digital subscriber line is (DSL) signal selected from the group consisting of: Asymmetric Digital Subscriber Line (ADSL), Rate Adaptive ADSL (RADSL), High Data Rate DSL (HDSL), Symmetric Digital Subscriber Line (SDSL), Very High Data Rate DSL (VDSL) and very High Speed ADSL (VADSL).

12. A communication system as claimed in claim 1, further comprising a radio receiver for receiving an RF signal transmitted by the radio transmitter, the receiver having means for recovering a digital subscriber line (DSL) signal from the RF signal.

13. A communication system as claimed in claim 12, wherein the receiver is coupled to transmit the DSL signal onto a telephone subscriber line.

14. A communication system as claimed in claim 12, wherein said receiver is coupled to transmit the DSL signal to one of a central office, a service provider and subscriber equipment.

15. A communication system as claimed in claim 14, wherein the receiver is connected to one of the central office, the service provider and the subscriber equipment, by a telephone subscriber line.

16. A communication system as claimed in claim 1, wherein the radio transmitter is arranged to receive DSL signals from a central office or subscriber equipment.

17. A communication system as claimed in 16, wherein the DSL signal from the central office or subscriber equipment is transmitted to the radio transmitter by a telephone subscriber line.

18. A communication system as claimed in claim 13, further comprising a second generator for generating a DSL signal, the DSL signal being transmitted on the same telephone subscriber line as the DSL signal output by the receiver, and a second radio transmitter having a converter for converting the DSL signal into a signal for wireless transmission.

19. A communication system as claimed in claim 18, wherein the first transmitter is arranged to receive DSL signals from a telephone subscriber line, and said system further comprises a second radio receiver for receiving the RF signal transmitted by the second radio transmitter, the second receiver having means for converting the RF signal into a DSL signal and outputting the DSL signal onto the same telephone subscriber line used for carrying DSL signals from the first generator to the first transmitter.

20. A communication system as claimed in claim 17, wherein the second generator is arranged to output the generated DSL signal onto the telephone subscriber line in the opposite direction to the DSL signal generated by the first generator.

21. A communication system as claimed in claim 19, wherein said second receiver is arranged to output the DSL signal onto said telephone subscriber in the opposite direction to the DSL signal output by said first receiver.

22. A communication system as claimed in claim 1, wherein said generator is coupled to said radio transmitter by a wire line and is arranged to output the generated DSL signal onto said wire line.

23. A wireless transmitter for use in a DSL communication system, comprising converter means for converting a DSL signal into an RF signal carrying data contained within the DSL signal, and radiating means for transmitting the RF signal.

24. A wireless transmitter as claimed in claim 23, wherein said converter means includes means for generating an RF carrier signal carrying said DSL signal.

25. A wireless transmitter as claimed in claim 23, wherein said converter means includes modulating means for modulating an RF carrier signal with said DSL signal.

26. A wireless transmitter as claimed in claim 23, further comprising a coupler adapted to couple said transmitter to a transmission line for carrying a DSL signal.

27. A wireless transmitter as claimed in claim 26, wherein said coupler is adapted to couple an input of said transmitter to a telephone subscriber line.

28. A wireless transmitter as claimed in claim 23, wherein the DSL signal comprises at least one of an ADSL formatted signal and a VDSL formatted signal.

29. A radio receiver for use in a digital subscriber line communication system comprising a receiver for receiving a wire less RF signal containing a DSL signal, and a converter for converting the RF signal into a different signal for further transmission of data contained within the DSL signal.

30. A radio receiver as claimed in claim 29, further comprising a coupler for coupling the output of said receiver to a transmission line.

31. A radio receiver as claimed in claim 30, wherein said converter is arranged to convert the RF signal into a DSL signal for transmission on a telephone subscriber line, and said coupler is adapted to couple the output to a telephone subscriber line.

32. A radio receiver as claimed in claim 29, wherein said converter comprises means for separating a DSL signal contained within said RF signal from an RF carrier signal.

33. A radio receiver as claimed in claim 32, wherein said converter comprises demodulating means for demodulating the RF signal.

34. A radio receiver as claimed in claim 29, wherein the RF signal contains at least one of an ADSL and a VDSL formatted signal.

35. A radio transceiver for use in a DSL communication system comprising a radio receiver having means for receiving a wireless RF signal containing DSL data, and a converter for converting the RF signal into a different signal for further transmission of the DSL data, and a radio transmitter having means for converting a DSL signal into an RF signal carrying data contained within the DSL signal and radiating means for transmitting the RF signal.

36. A radio transceiver as claimed in claim 35, wherein at least one frequency of the DSL signal received by the converter of the radio transmitter is different to at least one frequency of the DSL signal output from the converter of the radio receiver.

37. A method of conditioning a DSL signal comprising converting the DSL signal into an RP signal for wireless transmission.

38. A method of conveying a DSL signal comprising converting the DSL signal into an RF signal and wirelessly transmitting the RF signal.

39. A method of conveying a DSL signal comprising receiving a wireless RF signal containing a DSL signal and recovering the DSL signal from the RF signal.

40. A method as claimed in claim 39 wherein the DSL signal comprises an ADSL or a VDSL formatted signal.

41. A wireless radio wave carrier Carrying a DSL signal.
